(19) United States
(12) Patent Application Publication
(10) Pub. No.: US 2022/0111678 A1
(43) Pub. Date: Apr. 14, 2022

(54) Smart Magnetic Vent Plug

(71) Applicant: Valcrum, LLC, Cypress, TX (US)

(72) Inventors: Mario Robles, Cypress, TX (US); Alton Shelton, Cypress, TX (US)

(73) Assignee: Valcrum, LLC, Cypress, TX (US)

(21) Appl. No.: 17/421,878

(22) PCT Filed: Jan. 10, 2020
(86) PCT No.: PCT/US20/13211

§ 371 Date: Jul. 9, 2021

Related U.S. Application Data
(60) Provisional application No. 62/790,869, filed on Jan. 10, 2019.
(60) Provisional application No. 62/866,508, filed on Jun. 25, 2019.

(51) Int. Cl. B60B 7/00; F16C 33/66; F16C 33/72; F16C 41/00; G07C 5/00

(52) U.S. Cl. CPC B60B 7/002; F16C 33/667; F16C 33/723; F16C 41/007; G07C 5/008; B60B 2360/70; F16C 2233/00; B60B 2900/931; B60B 2360/10; B60B 2360/32; B60B 2360/50; F16C 2326/02

(57) ABSTRACT

The present disclosure is related to a hubcap vent plug that allows for simultaneous ventilation and debris collection of a hubcap comprising a magnet, a wireless communication sensor, and a plug body. In embodiments the wireless communication sensor is capable of monitoring internal characteristics of a hubcap. The plug body comprises an outer portion and an inner portion, wherein the outer portion comprises an external surface, an internal surface, a perimeter surface, and at least one borehole, and the inner portion comprises an outer lip, a magnet housing, and an internal gap.

### CROSS-REFERENCE TO RELATED APPLICATIONS

This application claims benefit of U.S. Application Ser. No. 62/790,869, filed Jan. 10, 2019, and U.S. Application Ser. No. 62/866,508, filed Jun. 25, 2019, the disclosures of which are incorporated by reference herein in their entirety.

### STATEMENT REGARDING FEDERALLY SPONSORED RESEARCH OR DEVELOPMENT

Not applicable.

### BACKGROUND OF THE INVENTION

### Field of the Invention

The present invention relates to a vehicle (e.g., a trailer) hubcap assembly, and more particularly to a vent plug for use with a vehicle hubcap assembly.

### Background of the Invention

A vehicle hubcap assembly may be installed on any vehicle hub to cover and/or protect the hub's inner components from exposure to dirt, dust, debris, and/or moisture. Typically, medium-duty to heavy-duty vehicles such as, without limitation, trucks, tractors, trailers, semi-trucks, and/or recreational vehicles utilize hubs such as oil bath hubs or grease hubs which may house a lubricant for inner components of the hub including, without limitation, wheel bearings and a spindle. By lubricating the wheel bearings about the spindle, the lifetime of the bearings may be extended and the operating friction of the bearings may be minimized. Hubcap assemblies for such medium-duty to heavy-duty vehicles may be used to fully enclose the lubricant within the hubs and prevent leakage of the lubricant.

During operation or transit of a vehicle, this enclosure and the lubricant within may experience an increase in temperature and/or pressure. In addition, the enclosure may experience a loss of lubricant, resulting in an internal development of metallic debris, caused by excessive friction between the wheel bearings and the spindle. All such instances may in turn be hazardous if unaddressed and may result in wheel bearing failure, thus incurring additional cost for an operator. Vent plugs of previous hubcap assemblies have attempted to addressed the temperature and pressure concern by providing a means of ventilating the enclosure and equalizing the pressure within, using at least one vent port. However, such vent plugs are unable to collect internal hubcap metallic debris (e.g. metal shavings) while simultaneously providing ventilation to the hubcap.

Further in regards to the temperature and pressure of a vehicle's hubs, an operator may lack a means to monitor such characteristics, and others, while the vehicle is in operation or transit. Currently, an operator must stop the vehicle, check each hub manually, and must do so regularly so as to avoid problems that may arise when the heat and pressure of a hubcap is too high. Manually monitoring can be inconvenient and time consuming, as well as unsafe should a hub enclosure overheat or become too highly pressurized during transit.

Consequently, there is a need for a vent plug for use with a vehicle hubcap assembly capable of effectively venting the enclosure of a vehicle hub while simultaneously collecting materials, such as metallic debris, within the hub. Further, there is a need for a vent plug that can monitor different characteristics of a vehicle hub during operation or transit of the vehicle.

### BRIEF SUMMARY OF SOME OF THE PREFERRED EMBODIMENTS

These and other needs in the art are addressed in one embodiment by a hubcap vent plug comprising a magnet and a plug body comprising an outer portion and an inner portion, wherein the outer portion comprises an external surface, an internal surface, and a borehole, and the inner portion comprises an outer lip, a magnet housing, and an internal gap.

These and other needs in the art are addressed in one embodiment by a hubcap vent plug comprising a magnet, a wireless communication sensor, wherein the wireless communication sensor monitors internal characteristics of a hubcap, and a plug body comprising an outer portion and an inner portion, wherein the outer portion comprises an external surface, an internal surface, a perimeter surface, and at least one borehole, and the inner portion comprises an outer lip, a magnet housing, and an internal gap.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1A illustrates a front isometric view of a vent plug in accordance with certain embodiments of the present disclosure;

FIG. 1B illustrates a side view of a vent plug in accordance with certain embodiments of the present disclosure;

FIG. 1C illustrates a rear isometric view of a vent plug in accordance with certain embodiments of the present disclosure;

FIG. 2A illustrates an assembled front isometric view of a hub cap assembly in accordance with certain embodiments of the present disclosure;

FIG. 2B illustrates a cross-sectional side view of a vent plug disposed on a hubcap in accordance with certain embodiments of the present disclosure in which a ventilation path is around a magnet;

FIG. 2C illustrates an exploded view of a hub cap assembly in accordance with certain embodiments of the present disclosure;

FIG. 3A illustrates a cross-sectional side view of a vent plug in accordance with certain embodiments of the present disclosure in which a ventilation path is around a magnet;

FIG. 3B illustrates a cross-sectional side view of a vent plug in accordance with certain embodiments of the present disclosure in which a ventilation path is through a magnet;

FIG. 4A illustrates a rear isometric view of a vent plug comprising a wireless communication sensor in accordance with certain embodiments of the present disclosure;

FIG. 4B illustrates a cross-sectional isometric view of a vent plug comprising a wireless communication sensor in accordance with certain embodiments of the present disclosure;

FIG. 5A illustrates a front isometric view of a vent plug comprising a wireless communication sensor disposed on a hubcap in accordance with certain embodiments of the present disclosure; and

FIG. 5B illustrates a cross-sectional side view of a vent plug comprising a wireless communication sensor in accordance with certain embodiments of the present disclosure in which a ventilation path is around a magnet.

### DETAILED DESCRIPTION OF THE PREFERRED EMBODIMENTS

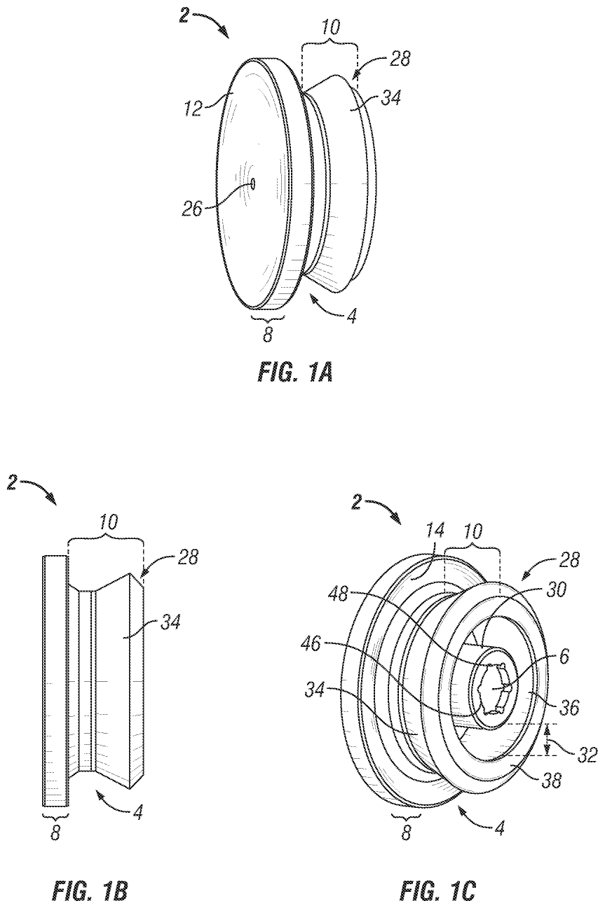

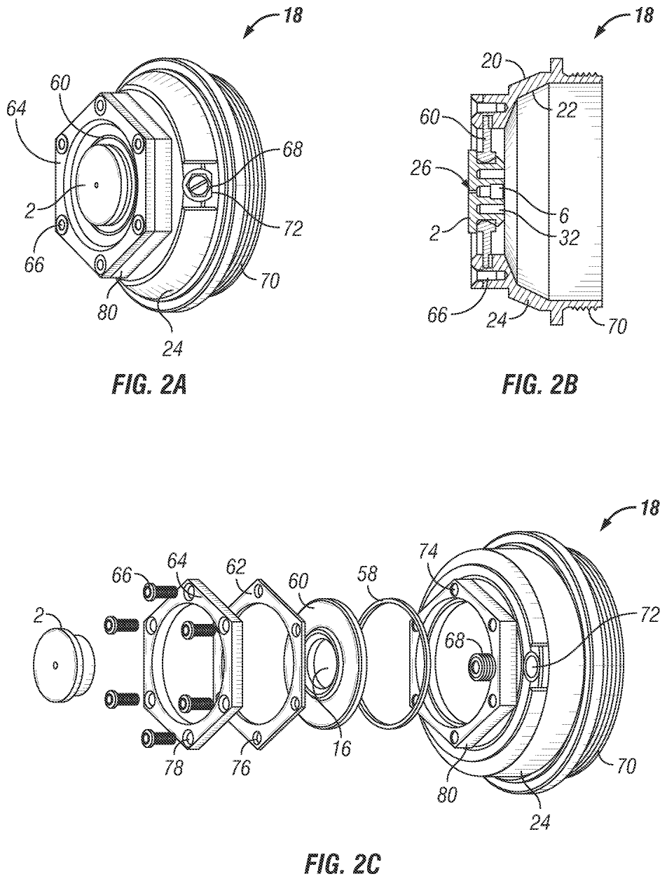

FIGS. 1A-1C illustrate an embodiment of a vent plug 2. Specifically, FIG. 1A illustrates an embodiment of vent plug 2 from a frontal isometric perspective, FIG. 1B illustrates an embodiment of vent plug 2 from a side perspective, and FIG. 1C illustrates an embodiment of vent plug 2 from a rearward isometric perspective. Vent plug 2 may be an apparatus capable of sealing and providing effective ventilation to a hubcap disposed on a vehicle hub. FIGS. 2A-2C illustrate an embodiment of a hubcap 18 that may be configured for use with vent plug 2. Specifically, FIG. 2A illustrates a fully assembled embodiment of hubcap 18 from a frontal isometric perspective, FIG. 2B illustrates a cross-section of a fully assembled embodiment of hubcap 18 from a side perspective, and FIG. 2C illustrates an exploded embodiment of hubcap 18 from a frontal isometric perspective. Hubcap 18 may be any suitable hubcap assembly such as an oil bath hubcap, dust cap, grease cap, and/or any combinations thereof. In embodiments, hubcap 18 may comprise vent plug 2, an oil enclosure 24, a first gasket 58, an oil indication window 60, a second gasket 62, a retainer ring 64, a plurality of screws 66, and an enclosure plug 68.

In embodiments, oil enclosure 24 may be any suitable compartment capable of storing oil, grease, and/or any combinations thereof. In embodiments, oil enclosure 24 may be composed of any suitable material such as, without limitation, metals, nonmetals, polymers, ceramics, and/or any combinations thereof. In embodiments, oil enclosure 24 may be composed of aluminum alloy. Additionally, oil enclosure 24 may be any suitable size and/or shape to allow for an operator to fasten oil enclosure 24 to a vehicle hub assembly. Oil enclosure 24 may comprise a threaded portion 70, a hexagonal portion 80, and a drain/fill port 72. Threaded portion 70 may be a section of oil enclosure 24 used to attach oil enclosure 24 to a vehicle hub assembly. Hexagonal portion 80 may be a section of oil enclosure 24 that comprises a plurality of drilled holes 74 capable of accepting plurality of screws 66. In embodiments, a diagonal of hexagonal portion 80, as measured form opposing edges may be from about 0.5 inches to about 5 inches, alternatively from about 1 inch to about 4 inches, alternatively from about 1.5 inches to about 3 inches, or alternatively from about 2 inches to about 2.5 inches. In embodiments, the diagonal of hexagonal portion 80 may be about 2.5 inches. Drain/fill port 72 may be an opening disposed on oil enclosure 24 that allows an operator to drain and/or fill oil enclosure 24 with oil and/or grease, and may further be sealed with enclosure plug 68. In embodiments, enclosure plug 68 may be threaded.

In embodiments, first gasket 58 may be a gasket disposed between oil enclosure 24 and oil indication window 60, and may be capable of enhancing the overall seal of hubcap 18. first gasket 58 may be composed on any suitable materials such as nonmetals, polymers, rubber, silicones, latex, elastomers, synthetics, and/or any combinations thereof. In embodiments, first gasket 58 may be composed of rubber. Additionally, first gasket 58 may be any suitable size and/or shape to allow for an effective seal between oil enclosure 24 and oil indication window 60 of hubcap 18. In embodiments, first gasket 58 may be circular in shape.

In embodiments, oil indication window 60 may be a layer of hubcap 18 disposed between first gasket 58 and second gasket 62, and may allow an operator to visually analyze the status and levels of oil and/or grease within oil enclosure 24. In embodiments, oil indication window 60 may be composed of any suitable material such as, without limitation, metals, nonmetals, polymers, ceramics, plastics, and/or any combinations thereof. In embodiments, oil indication window may be composed of a clear plastic material. Additionally, oil indication window 60 may be any suitable size and/or shape to allow for an effective seal between first gasket 58 and second gasket 62. In embodiments, oil indication window 60 may be circular in shape. Further, oil indication window 60 may comprise central port 16, to allow an operator access to oil enclosure 24. In embodiment, central port 16 may be threaded so as to accept vent plug 2.

In embodiments, second gasket 62 may be a gasket disposed between oil indication window 60 and retainer ring 64, and may be capable of enhancing the overall seal of hubcap 18. Second gasket 62 may be composed of any suitable materials such as nonmetals, polymers, rubber, silicones, latex, elastomers, synthetics, foams and/or any combinations thereof. In embodiments, second gasket 62 may be composed of foam. Additionally, second gasket 62 may be any suitable size and/or shape to allow for an effective seal between oil indication window 60 and retainer ring 64 of hubcap 18. In embodiments, second gasket 62 may be hexagonal in shape. In such an embodiment, a diagonal of second gasket 62, as measured form opposing edges may be from about 0.5 inches to about 5 inches, alternatively from about 1 inch to about 4 inches, alternatively from about 1.5 inches to about 3 inches, or alternatively from about 2 inches to about 2.5 inches. In embodiments, the diagonal of second gasket 62 may be about 2.5 inches. Additionally, second gasket 62 may comprise a plurality of holes 76 in which plurality of screws 66 may pass through.

In embodiments, retainer ring 64 may be an external ring capable of securing second gasket 62, oil indication window 60, and first gasket 58 to oil enclosure 24. Retainer ring 64 may comprise a plurality of drilled holes 78 which may align with plurality of holes 76 of second gasket 62 and plurality of drilled holes 74 of oil enclosure 24. In embodiments, plurality of screws 66, which may be composed of any suitable material, may be screwed through plurality of drilled holes 78 as well as plurality of holes 76, into plurality of drilled holes 74 so as to secure second gasket 62, oil indication window 60, and first gasket 58 to oil enclosure 24. Retainer ring 64 may be composed of any suitable material such as, without limitation, metals, nonmetals, polymers, ceramics, and/or any combinations thereof. In embodiments, retainer ring 64 may be composed of aluminum alloy. Additionally, retainer ring 64 may be any suitable size and/or shape to allow for an effective seal of all the components of hubcap 18 previously discussed. In embodiments, retainer ring 64 may be hexagonal in shape. In such an embodiment, a diagonal of retainer ring 64, as measured form opposing edges may be from about 0.5 inches to about 5 inches, alternatively from about 1 inch to about 4 inches, alternatively from about 1.5 inches to about 3 inches, or alternatively from about 2 inches to about 2.5 inches. In embodiments, the diagonal of retainer ring 64 may be about 2.5 inches.

Once again referring to FIGS. 1A-1C, embodiments of vent plug 2 may comprise a plug body 4, a magnet 6, and/or any combinations thereof. Plug body 4 may be molded and/or machined out of any suitable material such as, without limitation, metals, nonmetals, polymers, ceramics, rubber, silicones, latex, elastomers, synthetics, and/or any combinations thereof. Magnet 6 may be any suitable magnet such as, without limitation, a neodymium magnet, a samarium cobalt magnet, an alnico magnet, a ceramic or ferrite magnet, and/or any combinations thereof. Further, magnet 6 may be any suitable shape and/or size capable of being disposed within vent plug 2. In embodiments, magnet 6 may be, without limitation, rectangular, cylindrical, spherical, and/or any combinations thereof. In embodiments, magnet 6 may be cylindrically-shaped. In embodiments in which magnet 6 is cylindrically shaped, the diameter may be from about 0.125 inches to about 0.5 inches, alternatively from about 0.125 inches to about 0.375 inches, or alternatively from about 0.125 inches to about 0.25 inches. Further, the height of magnet 6 may be from about 0.0625 inches to about 0.25 inches, or alternatively from about 0.0625 inches to about 0.125 inches. In embodiments, magnet 6 may be installed into vent plug 2 or molded into place during an injection molding process of vent plug 2.

As further illustrated in FIGS. 1A-1C, plug body 4 may comprise an outer portion 8 and an inner portion 10. Outer portion 8 may comprise an external surface 12 and internal surface 14, and may be any suitable shape, sized and/or height. In embodiments, external surface 12 may be dimensioned and configured to cover central port 16 of hubcap 18 and internal surface 14 may be dimensioned and configured to rest adjacent to an external surface 20 of hubcap 18 (illustrated in FIGS. 2A and 2B). In embodiments, the shape of outer portion 8 may be, without limitation, circular, elliptical, triangular, rectangular, square, hexagonal, and/or any combinations thereof. In embodiments in which the shape of outer portion 8 is circular, as is illustrated in FIGS. 1A-1C, the diameter of outer portion 8 may be from about 0.125 inches to about 1.5 inches, alternatively from about 0.25 inches to about 1.25 inches, alternatively from about 0.5 inches to about 1.25 inches, or alternatively from about 0.75 inches to about 1.25 inches. In embodiments, the height of outer portion 8 may be from about 0.0625 inches to about 0.25 inches, or alternatively from about 0.0625 inches to about 0.125 inches. In embodiments, outer portion 8 may further comprise a borehole 26 disposed about any suitable location on outer portion 8. In embodiments, borehole 26 is disposed about a center axis of vent plug 2 (i.e. about the center of outer portion 8). Borehole 26 may be any suitable shape and/or size to provide effective ventilation for hubcap 18, while managing to prevent dirt, dust, debris, and/or moisture from entering hubcap 18 as well as leakage of oil from oil enclosure 24. In embodiments, borehole 26 may extend from external surface 12 to internal surface 14 creating a passageway through outer portion 8 toward inner portion 10.

In embodiments, inner portion 10 may comprise an outer lip 28, a magnet housing 30, an internal gap 32, and/or any combinations thereof. Inner portion 10 may be dimensioned and configured so as to extend through central port 16 of hubcap 18, so as to effectively seal oil enclosure 24 (illustrated in FIGS. 2A and 2B). In embodiments, outer lip 28 may comprise a curved outer surface 34 and a straight inner surface 36 such that curved outer surface 34 allows outer lip 28 to latch and/or fasten onto hubcap 18 by means of central port 16. FIG. 2B illustrates an embodiment in which curved outer surface 34 may rest adjacent to an internal surface 22 of hubcap 18. In embodiments, curved outer surface 34 may comprise threading used for attachment to hubcap 18. In embodiments, the cross-sectional shape of outer lip 28 may be, without limitation, circular, elliptical, triangular, rectangular, square, hexagonal, and/or any combinations thereof. Due to the nature of curved outer surface 34, the cross-sectional shape of outer lip 28 may vary in size, with the smallest cross-section occurring at the point in which internal surface 14 meets inner portion 10 and the largest cross-section occurring at the point in which curved outer surface 34 meets internal surface 22 o hubcap 18. In embodiments in which the cross-sectional shape of outer lip 28 is circular, as is illustrated in FIG. 2C, the smallest circular cross-section diameter (as measured from curved outer surface 34) may be from about 0.125 inches to about 1 inch, alternatively from about 0.25 inches to about 0.9375 inches, alternatively from about 0.5 inches to about 0.875 inches, or alternatively from about 0.75 inches to about 0.8125 inches. Further, the largest circular cross-section diameter (as measured from curved outer surface 34) may be from about 0.25 inches to about 1.5 inches, alternatively from about 0.5 inches to about 1.25 inches, alternatively from about 0.75 inches to about 1.125 inches, or alternatively from about 1 inch to about 1.0625 inches. In embodiments, the thickness of outer lip 28 (i.e., the distance between curved outer surface 34 and straight inner surface 36) may be from about 0.0625 inches to about 0.25 inches, alternatively from about 0.0625 inches to about 0.1875 inches, or alternatively from about 0.0625 inches to about 0.125 inches. In embodiments, the height of outer lip 28 (i.e., the distance between internal surface 14 and a lip surface 38) may be from about 0.125 inches to about 0.5 inches, alternatively from about 0.025 inches to about 0.4375 inches, or alternatively from about 0.3125 inches to about 0.375 inches. In embodiments, outer lip 28 may be disposed around magnet housing 30.

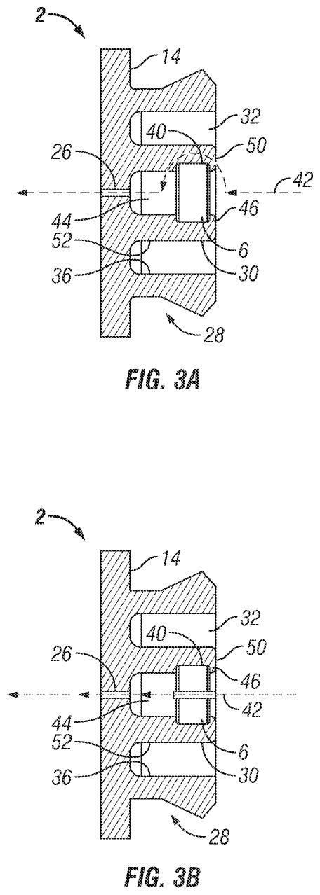

FIGS. 3A and 3B illustrate embodiments of magnet housing 30. Magnet housing 30 may be any suitable shape, size, and/or height capable of accepting and/or encasing magnet 6 while maintaining ventilation through vent plug 2. In embodiments, the height of magnet housing 30 (i.e., the distance between internal surface 14 and a housing surface 50) may correspond to the height of outer lip 28 and/or be from about 0.125 inches to about 0.5 inches, alternatively from about 0.025 inches to about 0.4375 inches, or alternatively from about 0.3125 inches to about 0.375 inches. Magnet housing 30 may be disposed about any location within outer lip 28 such that magnet housing 30 and outer lip 28 may be separated by internal gap 32. Internal gap 32 may be any suitable size to allow outer lip 28 the flexibility and capacity for movement when being faceted to hubcap 18. In embodiments, the thickness of internal gap 32 (i.e., the distance between straight inner surface 36 and an outer wall 52 of magnet housing 30) may be from about 0.0625 inches to about 0.25 inches, or alternatively from about 0.0625 inches to about 0.125 inches. In embodiments, magnet housing 30 may be disposed about the center axis of vent plug 2. Magnet housing 30 may comprise a magnet slot 40, ventilation pathways 42, a retention pit 44, and/or any combinations thereof.

In embodiments, magnet slot 40 may be the area in which magnet 6 is disposed within magnet housing 30. In embodiments, magnet slot 40 may be dimensioned and configured to hold and secure magnet 6. Further, magnet slot 40 may be configured with securing arms 46 in order to provide additional security in holding magnet 6. Securing arms 46 may be disposed on each side of magnet 6 in a mirrored configuration (i.e., the sides facing retention pit 44 and oil enclosure 24). In embodiments, magnet slot 40 may be configured with any number of securing arms 46 suitable for securing magnet 6. In embodiments, securing arms 46, may be separated by grooves 48 embedded in the walls of magnet slot 40 (illustrated in FIG. 1C). As such, grooves 48 may produce ventilation pathways 42 in magnet housing 30 extending from oil enclosure 24, around magnet 6, to retention pit 44. In embodiments, magnet slot 40 may have any number of grooves 48, and therefore magnet housing 30 may have any number of ventilation pathways 42. In embodiments, the number of grooves 48 and the number of ventilation pathways 42 leading to retention pit 44 may correspond to the number of securing arms 46. In an alternative embodiment, as illustrated in FIG. 3B, ventilation pathways 42 may be a single ventilation pathway through magnet 6 leading to retention pit 44.

In embodiments, retention pit 44 may be a chamber within magnet housing 30 at which ventilation pathways 42 connect to borehole 26. In embodiments, retention pit 44 may be a collection area for trapping dirt, dust, debris, and/or moisture that may enter magnet housing 30 through borehole 26 and/or ventilation pathways 42. In certain embodiments, magnet 6 may attract metallic debris entering from borehole 26 and/or ventilation pathways 42 and store such debris in retention pit 44. Trapping dirt, dust, debris, and/or moisture including, though not limited to, metallic debris in retention pit 44 may prevent a vehicle's wheel assembly and its components from being exposed to such debris as well as simultaneously provide ventilation to hubcap 18, particularly during transit.

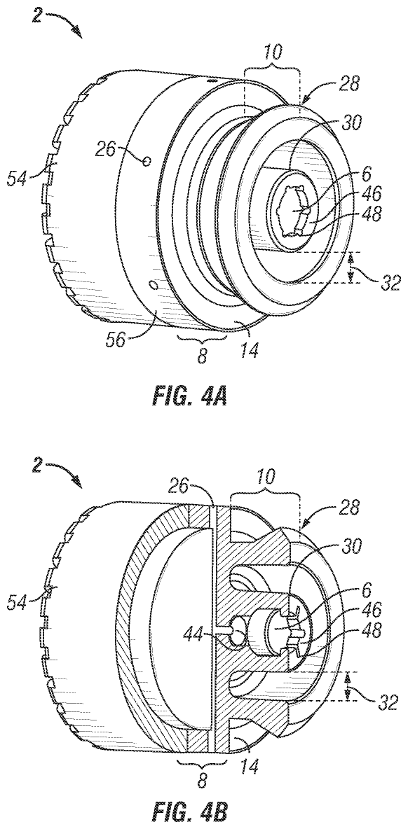

FIGS. 4A and 4B illustrate an embodiment of vent plug 2 comprising a wireless communication sensor 54. Wireless communication sensor 54 may be any wireless communication sensor capable of sensing and/or monitoring internal characteristics of hubcap 18. Internal characteristics may comprise, without limitation, temperature, pressure, oil level, mileage, malfunctions, or any combinations thereof. Additionally, wireless communication sensor 54 may communicate such characteristics via a wireless connection to a mobile device. The mobile device may comprise, without limitation, a mobile phone, smart phone, tablet, laptop computer, or a vehicle CPU. In embodiments, wireless communication may be accomplished, without limitation, via Bluetooth, satellite, radio, cellular network, Wi-Fi, or any combinations thereof. In further embodiments, wireless communication sensor 54 may notify a vehicle operator of any abnormal hubcap activity during transit. For example, wireless communication sensor 54 may communicate to a mobile device an overheating hubcap, an over-pressurized hubcap, a hubcap with low oil, or any combinations thereof. Any communication between wireless communication sensor 54 and a mobile device in operation may occur in real-time, near real-time, or nonreal-time while a vehicle is in transit or stationary. In embodiments, wireless communication sensor 54 may operate from any suitable power source such as, without limitation, batteries (disposable or rechargeable), solar panel, the vehicle in operation, or any combinations thereof.

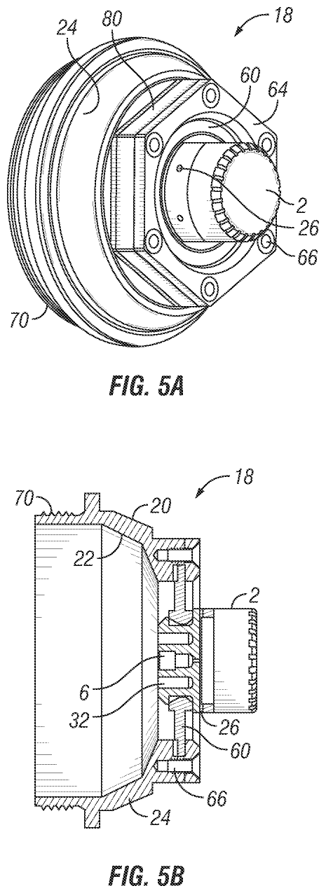

As illustrated in FIG. 4A, wireless communication sensor 54 may be dimensioned and configured to house any components necessary for monitoring hubcap 18. In embodiments, wireless communication sensor may be evenly disposed on external surface 12 of outer portion 8 by any suitable means. In embodiments, wireless communication sensor 54 may be attached to outer portion 8 via threading (not illustrated). In such an embodiment, the configuration of outer portion 8 may be modified such that borehole 26 is disposed on a perimeter surface 56 of outer portion 8. Further, perimeter surface 56 may comprise a plurality of boreholes 26. FIG. 4B illustrates a cross-sectional view of vent plug 2 comprising wireless communication sensor 54. Specifically, FIG. 4B illustrates the plurality of boreholes 26 extending from perimeter surface 56 to retention pit 44. In this particular embodiment, all other aspects of vent plug 2 may be the same as those previously discussed. FIGS. 5A and 5B illustrate how vent plug 2, comprising wireless communication sensor 54, may be disposed in hubcap 18. The configuration illustrated in FIGS. 5A and 5B are similar to the configurations illustrated in FIGS. 2A and 2B and show that both embodiments maybe fastened to hubcap 18 by similar means.

Although the present invention and its advantages have been described in detail, it should be understood that various changes, substitutions and alterations may be made herein without departing from the spirit and scope of the invention as defined by the appended claims.

What is claimed is:

1. A hubcap vent plug comprising:
a magnet; and
a plug body comprising:
an outer portion comprising an external surface, an internal surface, and a borehole; and
an inner portion comprising an outer lip, a magnet housing, and an internal gap.

2. The hubcap vent plug of claim 1, wherein the magnet is disposed within the magnet housing.

3. The hubcap vent plug of claim 1, wherein the plug body is composed of metals, nonmetals, polymers, ceramics, rubber, silicones, latex, elastomers, synthetics, or any combinations thereof.

4. The hubcap vent plug of claim 1, wherein the borehole extends through the outer portion from the external surface to the internal surface.

5. The hubcap vent plug of claim 1, wherein the outer lip is configured to fasten to a vehicle hubcap by means of a central port.

6. The hubcap vent plug of claim 1, wherein the magnet housing comprises a magnet slot, ventilation pathways, and a retention pit.

7. The hubcap vent plug of claim 6, where in the magnet slot is embedded with grooves which create the ventilation pathways, wherein the ventilation pathways extend from inside a hubcap to the retention pit to allow for simultaneous ventilation and debris collection.

8. The hubcap vent plug of claim 6, wherein the ventilation pathways connect to the borehole at the retention pit.

9. A hubcap vent plug comprising:
a magnet;
a wireless communication sensor, wherein the wireless communication sensor monitors internal characteristics of a hubcap; and
a plug body comprising:
an outer portion comprising an external surface, an internal surface, a perimeter surface, and at least one borehole; and
an inner portion comprising an outer lip, a magnet housing, and an internal gap.

10. The hubcap vent plug of claim 9, wherein the magnet is installed in the magnet housing.

11. The hubcap vent plug of claim 9, wherein the plug body is composed of metals, nonmetals, polymers, ceramics, rubber, silicones, latex, elastomers, synthetics, or any combinations thereof.

12. The hubcap vent plug of claim 9, wherein the wireless communication sensor is dimensioned so as to be evenly disposed on the external surface.

13. The hubcap vent plug of claim 9, wherein the at least one borehole extends through the outer portion from the perimeter surface to the internal surface.

14. The hubcap vent plug of claim 9, wherein the outer lip is configured to fasten to a vehicle hubcap by means of a central port.

15. The hubcap vent plug of claim 9, wherein the magnet housing comprises a magnet slot, ventilation pathways, and a retention pit.

16. The hubcap vent plug of claim 15, where in the magnet slot is embedded with grooves which create the ventilation pathways, wherein the ventilation pathways extend from inside a hubcap to the retention pit to allow for simultaneous ventilation and debris collection.

17. The hubcap vent plug of claim 15, wherein the ventilation pathways connect to the at least one borehole at the retention pit.

18. The hubcap vent plug of claim 9, wherein the internal characteristics comprise temperature, pressure, oil level, mileage, malfunctions, or any combinations thereof.

19. The hubcap vent plug of claim 9, wherein the wireless communication sensor can communicate the internal characteristic to a mobile device, vehicle CPU, or any combinations thereof.

20. A hubcap comprising:
an oil enclosure comprising a threaded portion, a hexagonal portion, and a drain/fill port, wherein the oil enclosure is composed of aluminum alloy;
a first gasket;
an oil indication window;
a second gasket;
a retainer ring;
an enclosure plug, wherein the enclosure plug seals the drain/fill port; and
a plurality of screws, wherein the plurality of screws fasten through the retainer ring and the second gasket into the oil enclosure, such that the first gasket, the oil indication window, the second gasket, and the retainer ring are held secure.
